(19) United States
(12) Patent Application Publication
(10) Pub. No.: US 2022/0128202 A1
(43) Pub. Date: Apr. 28, 2022

(54) CONTROL METHOD AND CONTROLLER FOR USB-POWERED COMBINATION TYPE LAMP STRIP

(71) Applicant: NINGBO GOLDEN POWER ELECTRONIC CO., LTD., NINGBO (CN)

(72) Inventor: ZHENGXIAN SHEN, NINGBO (CN)

(21) Appl. No.: 17/229,263

(22) Filed: Apr. 13, 2021

(30) Foreign Application Priority Data
Oct. 22, 2020 (CN) 202011140532.7

(51) Int. Cl. F21S 4/24; F21V 23/06; H05B 47/11

(52) U.S. Cl. CPC F21S 4/24; H05B 47/11; F21V 23/06

(57) ABSTRACT

The present invention provides a control method and controller for a USB-powered combination type lamp strip, and the method includes steps: S1, a working power source is provided for a lamp strip controller by a power attachment circuit; S2, a microcontroller unit (MCU) control circuit generates a control signal according to a signal collected by a collection circuit, and a drive circuit controls switching of lamp strip lighting modes according to the control signal. The controller is connected with a dichromatic diode to realize several control modes by combination of forward and backward voltages, the microcontroller unit pwm duty cycle, and forward and backward voltage supply durations, so that to realize the combination of multiple control modes, and then control the color of the lamp strip in multiple modes.

### CROSS-REFERENCE TO RELATED APPLICATIONS

This application claims priority to Chinese Application No. 202011140532.7, filed on Oct. 22, 2020. These contents are hereby incorporated by reference.

### TECHNICAL FIELD

The present invention relates to the field of circuit control technologies, and in particular to a control method and controller for a USB-powered combination type lamp strip.

### BACKGROUND

With the development of science and technology, illuminating apparatuses have more and more applications. The lamp strips of LED light sources become more and more which are usually used as atmosphere lamps. Along with continuous improvement of living level, users have more and more requirements for lamps rather than merely limited to ordinary monochromatic lighting. In the prior art, the lamp strips have single brightness, single color and single mode and so on, bringing poor experiences to the users.

### SUMMARY

In order to solve the above technical problems, the present invention provides a control method and controller for a USB-powered combination type lamp strip to control the color of the light strip by setting a variety of modes.

For the above technical problems, the present invention employs the following technical solution: a control method for a USB-powered combination type lamp strip, comprising the following steps:

S1, a working power source is provided for a lamp strip controller by a power attachment circuit;

S2, a microcontroller unit (MCU) control circuit generates a control signal according to a signal collected by a collection circuit, and a drive circuit controls switching of lamp strip lighting modes according to the control signal in the following settings:

S21, mode 2, forward always on;

S22, mode 3, backward always on;

S23, mode 4, forward and backward mixed color 1;

S24, mode 5, forward and backward mixed color 2;

S25, mode 6, color mixing gradient;

S26, mode 7, color mixing breathing flash;

S27, mode 8, forward flicker;

S28, mode 9, backward flicker;

S29, mode 10, single-side alternate brightness fading in and out;

S210, mode 11, forward and backward wave;

S211, mode 1, repeat S21 to S210 until the MCU control circuit receives a stop signal.

The above forward refers to a forward applied voltage and the above backward refers to a backward applied voltage.

Compared with the prior art, the present invention has the following advantages: the controller is connected with a dichromatic diode to realize several control modes by combination of forward and backward voltages, the microcontroller unit pwm duty cycle, and forward and backward voltage supply durations, so as to control the color of the light strip by setting a variety of modes.

Preferably, the collection circuit comprises a manual control circuit and a timing indication circuit for receiving a button switching signal, an infrared receiving circuit for receiving an infrared signal, and an audio control circuit for receiving a sound signal.

Preferably, in S25, S26, S29 and S210, the gray scale of the lamp strip gradually changes from a maximum to a minimum or from a minimum to a maximum.

Preferably, the MCU control circuit is further connected with an infrared remote control circuit which is internally provided with several buttons comprising a power switch button, a mode button, a brightness adjustment button, a speed adjusting button and a timing button.

Preferably, the brightness adjustment button comprises a brightness plus button and a brightness minus button, which are capable of adjusting the brightnesses of 10%, 30%, 50% and 100%, and the percentage is an output value of pulse width modulation (pwm) duty cycle.

Preferably, the speed adjustment button comprises a speed plus button and a speed minus button, which are capable of adjusting the speeds of four levels 1-4.

Preferably, the timing button comprises a TIME OFF button, a 6H button, a 8H button and a 6639H button. The 6H button means on 6H and off 18H, the 8H button means on 8H and off 16H, the 6639H button means on 6H, off 6H, on 3H and off 9H. When the 6H button, the 8H button and the 6639H button are selected, the TIME OFF button may be depressed to disable the timing. When the lamp strip performs mode switching, the timing is disabled.

Preferably, in S25 to S210, the brightness is of 50%.

The present invention further provides a USB-powered combination type lamp strip controller, comprising the following circuits:
a power attachment circuit, configured to supply power to all circuits in the lamp strip controller; a voltage stabilizing circuit, configured to stabilize a voltage input by the power attachment circuit;
an MCU control circuit, connected with the power attachment circuit and a bridge drive circuit;
a manual control circuit and a timing indicating circuit, connected with the MCU control circuit to receive a button switch signal to generate a lamp strip control signal;
an infrared receiving circuit, connected with the MCU control circuit to receive an infrared signal and transmit the infrared signal to MCU control circuit for processing so as to generate a lamp strip control signal;
an audio control circuit, connected with the MCU control circuit to transmit external sound signals collected to the MCU control circuit for processing so as to generate a lamp strip control signal;
a bridge drive circuit, connected with the voltage stabilizing circuit and the MCU control circuit to perform brightness mode switching for the lamp strip according to a drive signal output by the MCU control circuit.

Preferably, the power attachment circuit comprises a USB interface and a battery, and the battery is connected with a positive terminal of the USB interface.

### BRIEF DESCRIPTION OF THE DRAWINGS

FIG. 1 is a circuit diagram of a USB-powered combination type lamp strip controller according to an embodiment of the present invention.

### EMBODIMENTS

The embodiments of the present invention will be further detailed below in combination with the accompanying drawings.

### Embodiment One

The embodiment relates to a control method for a USB-powered combination type lamp strip, comprising the following steps:
S1, a working power source is provided to a lamp strip controller by a power attachment circuit.

In this step, the power attachment circuit comprises a USB interface and a battery. The USB interface is used as a primary power source, and the battery is connected with a positive terminal of the USB interface. The battery, as a secondary power source, can enable the entire controller to have a power-down memory function so that the controller can memorize the lamp strip modes set by the controller and corresponding brightness in a case of power-down.

S2, an MCU control circuit generates a control signal according to a signal collected by a collection circuit. The collection circuit comprises a manual control circuit and a timing indication circuit for receiving a button switching signal, an infrared receiving circuit for receiving an infrared signal, and an audio control circuit for receiving a sound signal. Several signals can be processed and several mode controls can be performed by the lamp strip easily at the same time, bringing about ease and convenience.

A drive circuit controls switching of lamp strip lighting modes according to the control signal in the following settings:

S21, mode 2, forward always on; apply a forward voltage to the lamp strip, and make it emit light of the first color at 100% brightness; the percentage is an output value of pulse width modulation (pwm) duty cycle.

S22, mode 3, backward always on; apply a backward voltage to the lamp strip, and make it emit light of the second color at 100% brightness;

S23, mode 4, forward and backward mixed color 1; apply a forward voltage to the lamp strip for a specific time as well as a backward voltage to the lamp strip for a specific time to make it emit light of both the first color and the second color at 100% brightness;

S24, mode 5, forward and backward mixed color 2, which is basically the same as mode 4, and the difference is that the specific time periods given in the two modes and the mixed light generated are different;

S25, mode 6, color mixing gradient; first apply a forward voltage, and the brightness of the first color provided by the forward voltage is gradually changed from 100% to 0%, and meanwhile apply a backward voltage, and the brightness of the second color provided by the backward voltage is gradually changed from 0% to 100%; the mixed light formed in this way can form multiple color subdivisions, and the subdivision time in this process is between 3.4-16 seconds.

In this process, a forward voltage can also be applied to gradually change the brightness of the first color provided by the forward voltage from 0% to 100%; meanwhile, apply a backward voltage to gradually change the brightness of the second color provided by the backward voltage from 100%-0%.

S26, mode 7, color mixing breathing flash; the voltage control method is the same as that of mode 6, the difference is that the duration of the voltage given and the colors displayed by the two modes are different, and the duration is between 1.4-5 seconds.

S27, mode 8, forward flicker; apply a forward voltage for a specific time, for example, the specific time is between 120-480 ms, and then turn it off for a certain period of time.

S28, mode 9, backward flicker; apply a backward voltage for a specific time, for example, the specific time is between 120-480 ms, and then turn it off for a certain period of time.

S29, mode 10, single-side alternate brightness fading in and out; first apply a forward voltage, and the brightness of the first color is gradually changed from 0%-100%-0%, and turn it off for a certain period of time; then apply a backward voltage, and the brightness of the second color is gradually changed from 0%-100%-0%; and turn it off.

S210, mode 11, forward and backward wave; first apply a forward voltage, and the brightness of the first color is gradually changed from 0% to 100%, meanwhile apply a backward voltage, and the brightness of the second color is gradually changed from 100% to 0%. The whole voltage signal is sequentially transmitted to each double-color diode of the lamp strip in this mode to form a wave shape.

S211, mode 1, repeat S21 to S210 until the MCU control circuit receives a stop signal.

In this embodiment, the MCU control circuit is further connected with an infrared remote control circuit which is internally provided with several buttons comprising a power switch button, a mode button, a brightness adjustment button, a speed adjusting button and a timing button.

The brightness adjustment button comprises a brightness plus button and a brightness minus button, which are capable of adjusting a maximum brightness of the lamp strip. In S25, S26, S29 and S210, the brightness can be modified by the brightness adjustment button at the levels of 10%, 30%, 50% and 100%.

In this embodiment, the speed adjustment button comprises a speed plus button and a speed minus button, which are capable of adjusting the speeds of four levels 1-4.

The timing button comprises a TIME OFF button, a 6H button, a 8H button and a 6639H button. The 6H button means on 6H and off 18H, the 8H button means on 8H and off 16H, the 6639H button means on 6H, off 6H, on 3H and off 9H. When the 6H button, the 8H button and the 6639H button are selected, the TIME OFF button may be depressed to disable the timing. When the lamp strip performs mode switching, the timing is disabled.

### Embodiment Two

S1, a working power source is provided to a lamp strip controller by a power attachment circuit.

In this step, the power attachment circuit comprises a USB interface and a battery. The USB interface is used as a primary power source, and the battery is connected with a positive terminal of the USB interface. The battery, as a secondary power source, can enable the entire controller to have a power-down memory function so that the controller can memorize the lamp strip modes set by the controller and corresponding brightness in a case of power-down.

S2, an MCU control circuit generates a control signal according to a signal collected by a collection circuit. The collection circuit comprises a manual control circuit and a timing indication circuit for receiving a button switching signal, an infrared receiving circuit for receiving an infrared signal, and an audio control circuit for receiving a sound signal. Several signals can be processed and several mode controls can be performed by the lamp strip easily at the same time, bringing about ease and convenience.

A drive circuit controls switching of lamp strip lighting modes according to the control signal in the following settings:

S21, mode 2, forward and backward wave; first apply a forward voltage, and the brightness of the first color is gradually changed from 0% to 100%; meanwhile apply a backward voltage, and the brightness of the second color is gradually changed from 100% to 0%. The whole voltage signal is sequentially transmitted to each double-color diode of the lamp strip in this mode to form a wave shape; the percentage is an output value of pulse width modulation (pwm) duty cycle.

S22, mode 3, forward and backward alternate flicker; apply a forward voltage to the lamp strip, and make it emit light of the first color at 100% brightness; and after a specific time, shift to a backward voltage to make the lamp strip to emit light of the second color at 100% brightness. The specific time is between 125-1000 milliseconds.

S23, mode 4, single-side alternate brightness fading in and out; first apply a forward voltage, and the brightness of the first color is gradually changed from 0%-100%-0%, and turn it off for a certain period of time; then apply a backward voltage, and the brightness of the second color is gradually changed from 0%-100%-0%; and turn it off. Each gradual change process is between 5.6-6.7 seconds, and each off time is between 270-580 milliseconds.

S24, mode 5, forward and backward alternate flicker and star flicker; apply a forward voltage to the lamp strip for a certain period of time, and make it emit light of the first color at 100% brightness; and then shift to a backward voltage for a certain period of time to make the lamp strip to emit light of the second color at 100% brightness to achieve an alternate flicker effect. Then apply a forward voltage to the lamp strip for a certain period of time, and make it emit light of the first color at 100% brightness; and then shift to a backward voltage for a certain period of time to make the lamp strip to emit light of the second color at 100% brightness.

S25, mode 6, double lamps brightness fading in and out; apply a forward voltage to the lamp strip, and the brightness of the first color is gradually changed from 0%-100%-0%; meanwhile apply a backward voltage, and the brightness of the second color is gradually changed from 0%-100%-0% and then turn the lamp strip off.

S26, mode 7, star flicker; apply a forward voltage to the lamp strip for a certain period of time, and make it emit light of the first color at 100% brightness; and then apply a backward voltage for a certain period of time to make the lamp strip to emit light of the second color at 100% brightness.

S27, mode 8, always on, apply a forward voltage to the lamp strip, and make it emit light of the first color at 100% brightness; or apply a backward voltage to the lamp strip, and make it emit light of the second color at 100% brightness.

S28, mode 1, repeat S21 to S27 until the MCU control circuit receives a stop signal.

In this embodiment, the MCU control circuit is further connected with an infrared remote control circuit which is internally provided with several buttons comprising a power switch button, a mode button, a brightness adjustment button, a speed adjusting button and a timing button.

The brightness adjustment button comprises a brightness plus button and a brightness minus button, which are capable of adjusting a maximum brightness of the lamp strip. In S21, S23, and S25, the maximum brightness can be modified by the brightness adjustment button at the levels of 10%, 30%, 50% and 100%.

In this embodiment, the speed adjustment button comprises a speed plus button and a speed minus button, which are capable of adjusting the speeds of four levels 1-4.

The timing button comprises a TIME OFF button, a 6H button, an 8H button and a 6639H button. The 6H button means on 6H and off 18H, the 8H button means on 8H and off 16H, the 6639H button means on 6H, off 6H, on 3H and off 9H. When the 6H button, the 8H button and the 6639H button are selected, the TIME OFF button may be depressed to disable the timing. When the lamp strip performs mode switching, the timing is disabled.

In this embodiment, the highest brightness is 50% in step S25 to step S210 when the power is turned on for the first time.

### Embodiment Three

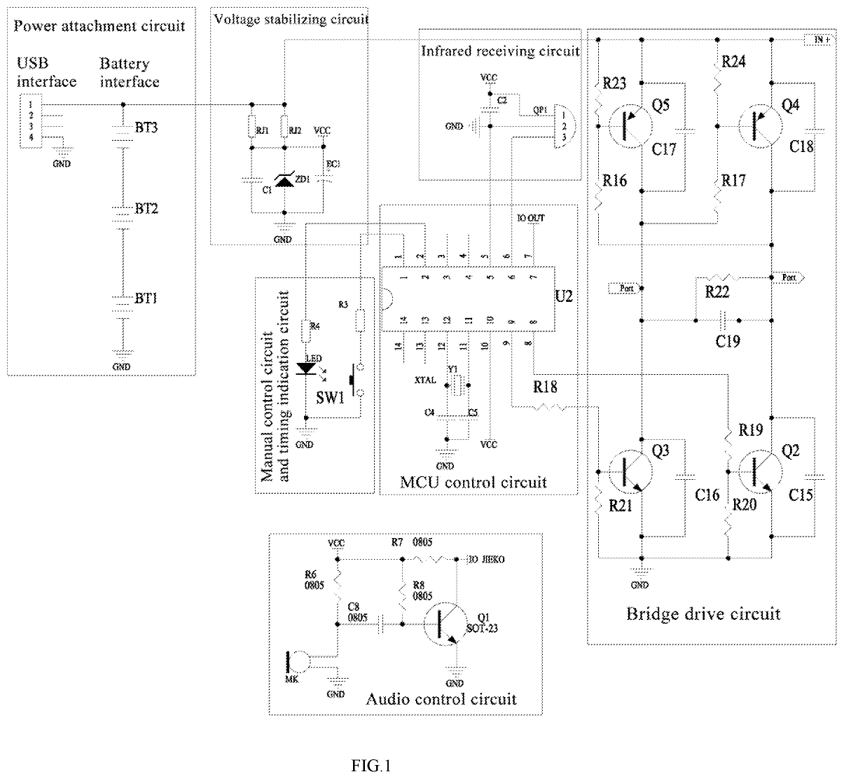

As shown in FIG. 1, the example relates to a USB-powered combination type lamp strip controller, comprising the following circuits: a power attachment circuit, a voltage stabilizing circuit, an MCU control circuit, a manual control circuit, a timing indication circuit, an infrared receiving circuit, an audio control circuit, and a bridge drive circuit.

The power attachment circuit is configured to provide power to all circuits inside the lamp strip controller. The power attachment circuit comprises a USB interface and a battery, the battery is connected with a positive terminal of the USB interface. The USB interface is used as a primary power source to provide power to the entire controller and the battery can guarantee the power-down memory of the controller.

The voltage stabilizing circuit is configured to stabilize a voltage input by the power attachment circuit. The voltage stabilizing circuit comprises a resistor RJ1, a resistor RJ2, a capacitor C1, a capacitor EC1 and a diode ZD1, the positive terminal of the USB interface is series-connected with the resistor RJ1 and the capacitor C1 and grounded, the positive terminal of the USB interface is connected to a negative pole of the diode ZD1 through the resistor RJ2, the diode ZD1 is grounded, the capacitor EC1 is parallel-connected with two ends of the diode ZD1, the connection ends of the resistor RJ1 and the capacitor C1 and the connection ends of the resistor RJ2 and the diode ZD1 are all connected to VCC.

The MCU control circuit is connected with the power attachment circuit and a bridge drive circuit. The MCU control circuit comprises a microcontroller unit, capacitors C4, C5 and a crystal oscillator Y1. One end of the capacitors C4 and C5 is connected to the microcontroller unit respectively and the other end of the capacitors C4 and C5 is grounded, and the crystal oscillator Y1 is disposed between C4 and C5.

The manual control circuit and the timing indication circuit are connected with the MCU control circuit to receive a button switching signal to generate a lamp strip control signal. The manual control circuit and the timing indication circuit comprise resistors R3 and R4, LED and button SW1. Both ends of the manual control circuit and the timing indication circuit are connected to the microcontroller unit, the resistor R4 and the LED are grounded in series connection, the resistor R3 and the button SW1 are grounded in series connection. When the button SW1 is depressed, the circuit is turned on, the microcontroller unit receives a trigger signal to generate a lamp strip control signal, thereby realizing manual control.

The infrared receiving circuit is connected with the MCU control circuit to receive an infrared signal and transmit the infrared signal to the MCU control circuit for processing, so as to generate a lamp strip control signal.

The audio control circuit is connected with the MCU control circuit to transmit external sound signals collected to the MCU control circuit for processing so as to generate a lamp strip control signal. The audio control circuit comprises resistors R6, R7 and R8, a capacitor C8, a triode Q1 and a microphone MK. The microphone is used to receive a sound signal and convert the sound signal into an electrical signal. One end of the MK is grounded and the end of the MK is connected to C8 connected with a base of the Q1, one end of the R6 is connected between MK and C8, and the other end of the R6 is connected to the power source VCC, the base of the Q1 is further connected to R8, one end of which is connected to the power source VCC, a collector of the Q1 is connected with R7 and also connected with the microcontroller unit of the MCU control circuit, and an emitter of the Q1 is grounded. The audio control circuit receives an external sound signal and transmits the sound signal to the microcontroller unit so that the microcontroller unit generates a control signal.

The bridge drive circuit is connected with the voltage stabilizing circuit and the MCU control circuit to perform lighting mode switching for the lamp strip according to a drive signal output by the MCU control circuit. The lighting mode can be controlled by a write program of the microcontroller unit. The bridge drive circuit comprises triodes Q2, Q3, Q4, Q5, capacitors C15, C16, C17, C18, C19, resistors R16, R17, R18, R19, R20, R21, R22, R23 and R24.

A base of the triode Q5 is connected to a collector of the triode Q4 through a resistor R16, and connected to a emitter of the triode Q5 through the resistor R23, a base of the triode Q4 is connected to a collector of the triode Q5 through the resistor R17, and connected to an emitter of the triode Q4 through the resistor R24, and the capacitor C17 and the capacitor C18 are parallel-connected between the collector and the emitter of the triode Q5 and the triode Q4. The emitter of the triode Q5 is connected to the emitter of the triode Q4 and connected to the positive terminal of the USB interface.

A collector of the triode Q3 is connected with the collector of the triode Q5, a collector of the triode Q2 is connected with the collector of the triode Q4, and a base of the triode Q2 and a base of the triode Q3 are connected to a pin of the microcontroller unit through R19 and R18 respectively. The emitters of the triodes Q2 and Q3 are both grounded, the base of the triode Q3 is grounded through R21, the base of the triode Q2 is grounded through the resistor R20, the capacitor C15 and the capacitor C16 are parallel-connected between the collector and the emitter of the triode Q2 and the triode Q3 respectively, the resistor R22 is disposed between the collector of the triode Q3 and the collector of the triode Q2, and the capacitor 19 is further parallel-connected at two ends of the resistor R22.

The present invention has the following beneficial effects: the controller is connected with a dichromatic diode to realize several control modes by combination of forward and backward voltages, the microcontroller unit pwm duty cycle, and forward and backward voltage supply durations, so that multi-mode color control can be performed for the lamp strip.

The preferred embodiments of the present invention are illustrated and described as above. As mentioned above, it should be understood that the present invention is not limited to the forms disclosed in the present invention and shall not be regarded as exclusion to other embodiments. The present invention can be applied in various other combinations, modifications or environments and can be modified or changed by use of relevant techniques and knowledge under the above teachings without departing from the scope of the present invention. Those changes or modifications made by those skilled in the art shall not depart from the spirit and scope of the present invention and shall all fall within the scope of protection claimed by the appended claims of the present invention.

I claim:

1. A control method for a USB-powered combination type lamp strip, wherein it comprises the following steps:
S1, a working power source is provided for a lamp strip controller by a power attachment circuit;
S2, a microcontroller unit (MCU) control circuit generates a control signal according to a signal collected by a collection circuit, and a drive circuit controls switching of lamp strip lighting modes according to the control signal in the following settings:
S21, mode 2, forward always on;
S22, mode 3, backward always on;
S23, mode 4, forward and backward mixed color 1;
S24, mode 5, forward and backward mixed color 2;
S25, mode 6, color mixing gradient;
S26, mode 7, color mixing breathing flash;
S27, mode 8, forward flicker;
S28, mode 9, backward flicker;
S29, mode 10, single-side alternate brightness fading in and out;
S210, mode 11, forward and backward wave;
S211, mode 1, repeat S21 to S210 until the MCU control circuit receives a stop signal;
the above forward refers to a forward applied voltage and the above backward refers to a backward applied voltage.

2. The control method for a USB-powered combination type lamp strip of claim 1, wherein the collection circuit comprises a manual control circuit and a timing indication circuit for receiving a button switching signal, an infrared receiving circuit for receiving an infrared signal, and an audio control circuit for receiving a sound signal.

3. The control method for a USB-powered combination type lamp strip of claim 1, wherein in S25, S26, S29 and S210, the gray scale of the lamp strip gradually changes from a maximum to a minimum or from a minimum to a maximum.

4. The control method for a USB-powered combination type lamp strip of claim 3, wherein the MCU control circuit is further connected with an infrared remote control circuit which is internally provided with several buttons comprising a power switch button, a mode button, a brightness adjustment button, a speed adjusting button and a timing button.

5. The control method for a USB-powered combination type lamp strip of claim 4, wherein the brightness adjustment button comprises a brightness plus button and a brightness minus button, which are capable of adjusting the brightnesses of 10%, 30%, 50% and 100%; the percentage is an output value of pulse width modulation (pwm) duty cycle.

6. The control method for a USB-powered combination type lamp strip of claim 4, wherein the speed adjustment button comprises a speed plus button and a speed minus button, which are capable of adjusting the speeds of four levels 1-4.

7. The control method for a USB-powered combination type lamp strip of claim 4, wherein the timing button comprises a TIME OFF button, a 6H button, an 8H button and a 6639H button. The 6H button means on 6H and off 18H, the 8H button means on 8H and off 16H, the 6639H button means on 6H, off 6H, on 3H and off 9H; when the 6H button, the 8H button and the 6639H button are selected, the TIME OFF button may be depressed to disable the timing, and when the lamp strip performs mode switching, the timing is disabled.

8. The control method for a USB-powered combination type lamp strip of claim 5, wherein in S25 to S210, the brightness is of 50%.

9. A USB-powered combination type lamp strip controller, comprising the following circuits:
a power attachment circuit, configured to supply power to all circuits in the lamp strip controller;
a voltage stabilizing circuit, configured to stabilize a voltage input by the power attachment circuit;
an MCU control circuit, connected with the power attachment circuit and a bridge drive circuit;
a manual control circuit and a timing indicating circuit, connected with the MCU control circuit to receive a button switch signal to generate a lamp strip control signal;
an infrared receiving circuit, connected with the MCU control circuit to receive an infrared signal and transmit the infrared signal to MCU control circuit for processing so as to generate a lamp strip control signal;
an audio control circuit, connected with the MCU control circuit to transmit external sound signals collected to the MCU control circuit for processing so as to generate a lamp strip control signal;
a bridge drive circuit, connected with the voltage stabilizing circuit and the MCU control circuit to perform brightness mode switching for the lamp strip according to a drive signal output by the MCU control circuit.

10. The USB-powered combination type lamp strip controller of claim 9, wherein the power attachment circuit comprises a USB interface and a battery, and the battery is connected with a positive terminal of the USB interface.
